(19) United States
(12) Patent Application Publication
(10) Pub. No.: US 2009/0207446 A1
(43) Pub. Date: Aug. 20, 2009

(54) PRINTING SYSTEM, CONTROL METHOD, STORAGE MEDIUM, PROGRAM, AND PRINTING APPARATUS

(75) Inventor: Masamichi Akashi, Funabashi-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/389,104

(22) Filed: Feb. 19, 2009

(30) Foreign Application Priority Data
Feb. 19, 2008 (JP) 2008-037565

(51) Int. Cl. G06F 3/12

(52) U.S. Cl. 358/1.15

(57) ABSTRACT

A client PC that can cause an image processing apparatus to print a job including multiple printed materials in one job, and has a describing unit to describe information relating to post-processing performed as to a portion of printed material of the multiple printed materials printed by the image processing apparatus, as a statement of instruction, and outputs the statement of instruction described with the describing unit with an outputting unit.

### BACKGROUND OF THE INVENTION

1. Field of the Invention

The present invention relates to a printing system, control method, storage medium, and printing apparatus, more specifically, creating a statement of instruction.

2. Description of the Related Art

Currently, enabling use of a statement of instruction (also called a job ticket) wherein information relating to post-processing is described in the case of performing post-processing as to printed materials created with a printing apparatus is being researched with a POD (Print on Demand) printing system and so forth. Proposals have also been made relating to such a printing system that generates a statement of instruction for printed materials (For example, U.S. Pat. No. 6,727,999).

However, there is room for much more research before the realization of a product that enables creating a statement of instruction. Currently, to give an example of a job to create 100 sets (100 copies) of a printed material, the only research is for a statement of instruction to be output upon all of the 100 sets of printed materials having been created. With this situation, a statement of instruction can only be created at a timing fixed beforehand.

Considering this situation, it is thought to be important to provide an arrangement enabling flexibility relating to the timing to create the statement of instruction, so as not to have a situation wherein a statement of instruction can only be created with restricted timing.

Also, as a result of resolving to prevent such a situation as described above, it is also thought to be important to prevent a situation causing new problems, such as a statement of instruction created for inappropriate work content (instruction content) that can cause errors to the work thereafter. For example, let us say that even though the 100 sets of printed material have not been completed, a statement of instruction is created that describes the work content as all printed material having been created. This results in a situation wherein work content is described in the statement of instruction for 100 sets worth of printed material but fewer than 100 sets worth of printed material is at hand. With such a situation, problems can occur, such as a worker becoming confused during post-processing thereof (process after printing), or inappropriate work being performed at a post-processor.

### SUMMARY OF THE INVENTION

An embodiment of the present invention provides an arrangement whereby such situations that may occur hereafter can be presumed, and provides flexibility relating to the timing for creating a statement of instruction.

Also, an aspect of the present invention provides an arrangement wherein the timing for creating a statement of instruction can be controlled in accordance with the situation of a printing apparatus (printing system) or by request from an operator.

Additionally, an aspect of the present invention provides an arrangement wherein the statement of instruction has appropriate content described therein, so that even in a case that the timing for creating a statement of instruction can be controlled, problems do not occur in the subsequent work.

Another aspect of the present invention provides an arrangement that contributes to the realization of products which enable the creation of a statement of instruction.

In yet another aspect of the present invention, an information processing apparatus that can cause a printing unit to print a job including multiple printed materials in one job, includes: a describing unit that describes information relating to post-processing performed as to a portion of the printed material of the multiple printed material to be printed with the printing unit, as a statement of instruction to be outputted by an outputting unit.

According to another aspect of the present invention, an image forming apparatus includes: a printing unit to print multiple printed materials included in one job; and an outputting unit to output a statement of instruction wherein information is described relating to post-processing performed as to a portion of the printed material of the multiple printed materials output by the printing unit.

According to another aspect of the present invention, a printing system that can cause a printing unit to print a job including multiple printed materials in one job, includes: a describing unit that describes information relating to post-processing performed as to a portion of the printed material of the multiple printed material to be printed with the printing unit, as a statement of instruction; and an outputting unit that outputs the statement of instruction described with the describing unit.

According to another aspect of the present invention, an information processing method includes the steps of: printing a job including multiple printed materials in one job; describing information relating to post-processing performed as to a portion of the printed material of the multiple printed material to be printed in the printing step, as a statement of instruction; and outputting the statement of instruction described in the describing step.

According to another aspect of the present invention, provided is a program to cause a computer to execute each step of the information processing method.

In yet another aspect of the present invention, provided is a computer-readable storage medium wherein a program to cause a computer to execute each step of the information processing method is stored.

According to another embodiment of the present invention, for example, an arrangement whereby situations such as described in the related art that may occur hereafter can be presumed, and an arrangement having flexibility relating to the timing for creating the statement of instruction, can be provided. Also, according to an aspect of the present invention, for example, an arrangement can be provided wherein the timing for creating the statement of instruction can be controlled in accordance with the situation of the printing apparatus (printing system) or by request from the operator. Also, according to another aspect of the present invention, for example, an arrangement can be provided that can create a statement of instruction having appropriate content described therein, so that even in a case that the timing for creating a statement of instruction can be controlled, problems do not occur in the subsequent work. Thus, according to an embodiment of present invention, an arrangement that contributes to the realization of products which enable the creation of a statement of instruction can be provided.

Further features of the present invention will become apparent from the following description of exemplary embodiments with reference to the attached drawings.

### BRIEF DESCRIPTION OF THE DRAWINGS

FIG. 1 is a drawing illustrating the configuration of an entire Print on Demand printing system including a printing system.

FIG. 2 is a block diagram illustrating a configuration of an image forming apparatus to function as a printing system.

FIG. 3 is a drawing illustrating a user interface screen.

FIG. 4 is a drawing illustrating a user interface screen.

FIG. 5 is a drawing illustrating an example of a statement of instruction.

FIG. 6 is a flowchart illustrating a specific example of control relating to the creation of the statement of instruction.

FIG. 7 is a drawing illustrating a user interface screen.

FIG. 8 is a drawing illustrating a user interface screen.

FIG. 9 is a flowchart illustrating a specific example of control relating to the creation of the statement of instruction.

FIG. 10 is a drawing illustrating a user interface screen.

FIG. 11 is a drawing illustrating a user interface screen.

FIG. 12 is a flowchart illustrating a specific example of control relating to the creation of the statement of instruction.

FIG. 13 is a flowchart illustrating a specific example of control relating to the creation of the statement of instruction.

FIG. 14 is a flowchart illustrating a specific example of control relating to the creation of the statement of instruction.

FIG. 15 is a drawing illustrating an example of a statement of instruction.

FIG. 16 is a drawing illustrating a user interface screen.

### DESCRIPTION OF THE EMBODIMENTS

Hereafter, embodiments of the present invention will be described in detail with reference to the appended drawings. Note that hereafter in the description of the embodiments, an image forming apparatus 102 is exemplified as a printing apparatus applicable to a Print on Demand (hereinafter abbreviated to “POD”) printing system. As a post-processing apparatus to perform post-processing as to the printed material created with this printing apparatus, a device called a finisher is exemplified, which is described below as categorized into 3 types.

The first categorized type of post-processing apparatus is configured so as to be physically connectable to a printing apparatus (image forming apparatus 102 of the present embodiment, for example). This type of post-processing apparatus is configured such that sheets printed with the printing apparatus can be directly supplied to a post-processing unit within the printing apparatus via a transporting path within the apparatus, without intervening work such as an operator transporting the sheets. This type of post-processing apparatus is called an “inline finisher”. Note that the inline finisher is configured so that the printed material can be subjected to post-processing set by the operator with the user interface of the printing apparatus.

The second categorized type of post-processing apparatus is connected to a network, and is configured so as to enable data communication with other apparatuses. However, this type of post-processing apparatus is not physically connected to the printing apparatus, and in order to perform post-processing as to the printed material with this apparatus, the sheets subjected to printing with the printing apparatus have to be set in the post-processing apparatus via manual work by an operator. Note that this type of post-processing apparatus is configured so as to interpret electronic data that identifies instruction content of the post-processing described in the later-described statement of instruction, and so that the post-processing identified by the data can be executed as to the printed material. This type of post-processing apparatus is called a “near line finisher”.

The third categorized type of post-processing apparatus is not connected to a network, and has no data communication capability with other apparatuses. This post-processing apparatus is also not physically connected to a printing apparatus. In the case of performing post-processing as to printed material with this type of post-processing apparatus, the sheets subjected to printing with the printing apparatus have to be set in the post-processing apparatus via manual work by an operator, and post-processing that an operator is to execute has to be instructed via an operating unit provided on such apparatus. This type of post-processing apparatus is called an “offline finisher”.

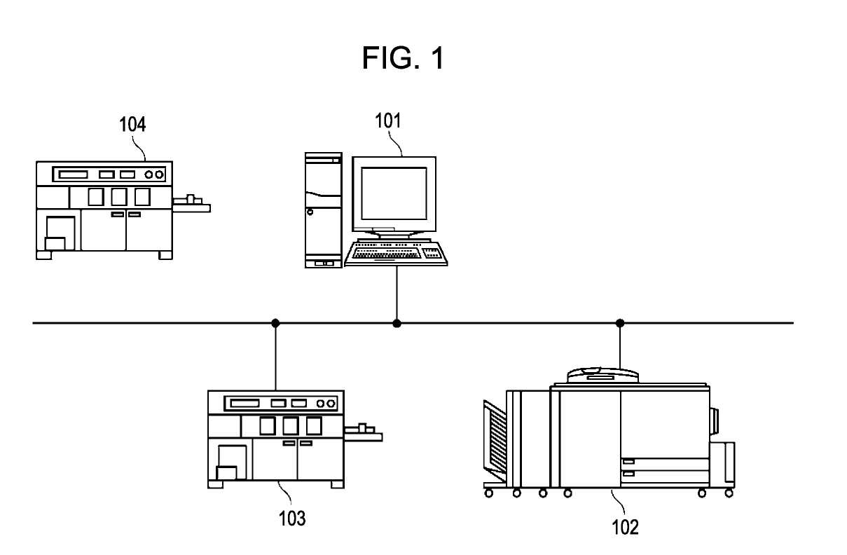

FIG. 1 is a block diagram illustrating a configuration of a POD printing system according to an embodiment of the present invention. In FIG. 1, the POD printing system has a client PC 101, image forming apparatus (also called a printer or printing apparatus) 102, a near line finished 103 connected to a network, and an offline finisher 104 not connected to a network. The image forming apparatus 102 processes a job received from the client PC 101, and prints the printed material according to the job. A job is data including content to be printed as printed material which is sent to the image forming apparatus (hereafter, referred to simply as “printed material”) with one-time instructions by a user of the client PC 101. Also, with the present invention, a job to be processed includes multiple printed materials within one job, and a printed material is made up of one or more pages.

Note that according to the present embodiment, the image forming apparatus 102 functions as the printing system of the present invention, and an unshown inline finisher is connected thereto. This inline finisher has a configuration equivalent to printed material receiving units such as a sheet transporting path and processing tray to receive printed material created with the image forming apparatus 102 without intervening work by an operator. With the present embodiment, the printed material created with the image forming apparatus 102 can be subjected to desired post-processing using the inline finisher.

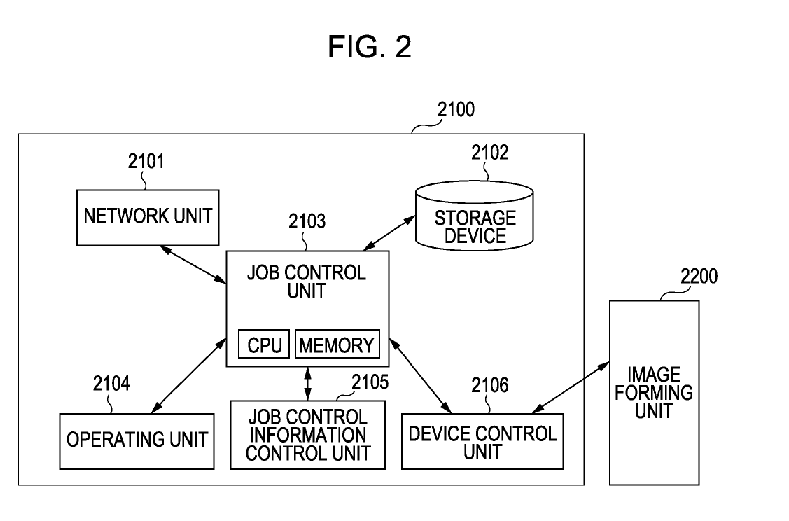

FIG. 2 is a detailed block diagram of the image forming apparatus 102. In FIG. 2, the image forming apparatus 102 which functions as a printing system with the present embodiment has an image forming unit (hereafter, printer unit) 2200 that functions as a printing unit, an unshown inline finisher, and a controller 2100 that controls the printer unit 2200 and inline finisher. The controller 2100 is made up of a network unit 2101, storage apparatus 2102, job control unit 2103, operating unit 2104, job control information control unit 2105, device control unit 2106, and so forth.

Note that with the present embodiment, the controller 2100 functions as a control unit, and various types of controls for the printing system of the present embodiment are executed with the controller 2100. For example, the controller 2100 receives a printing request for printed material for a job to be processed, and causes the printer unit 2200 to print the printed material for such job (equivalent to the main document in the later-described description). Thus, the controller 2100 performs printing controls necessary for creating printed material which will be subject to post-processing with one of the three above-described types of finishers.

Also, the controller 2100 that functions as the control unit also functions as a determining unit to determine output timing of a statement of instruction wherein information relating to post-processing performed for the printed material created by the printer unit 2200 is described.

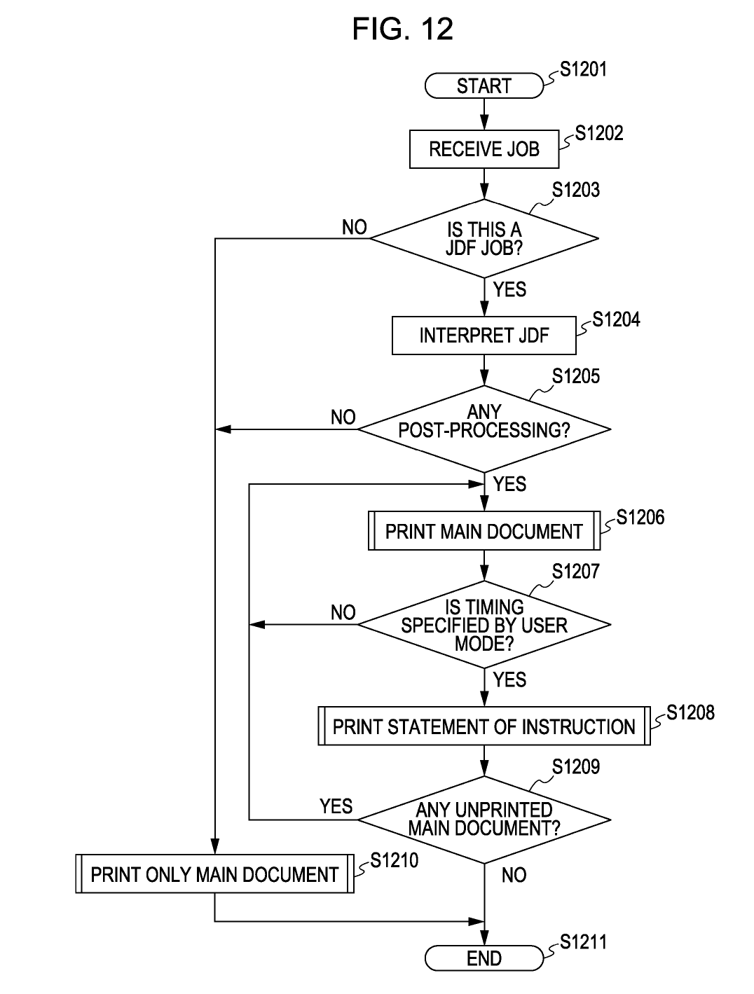

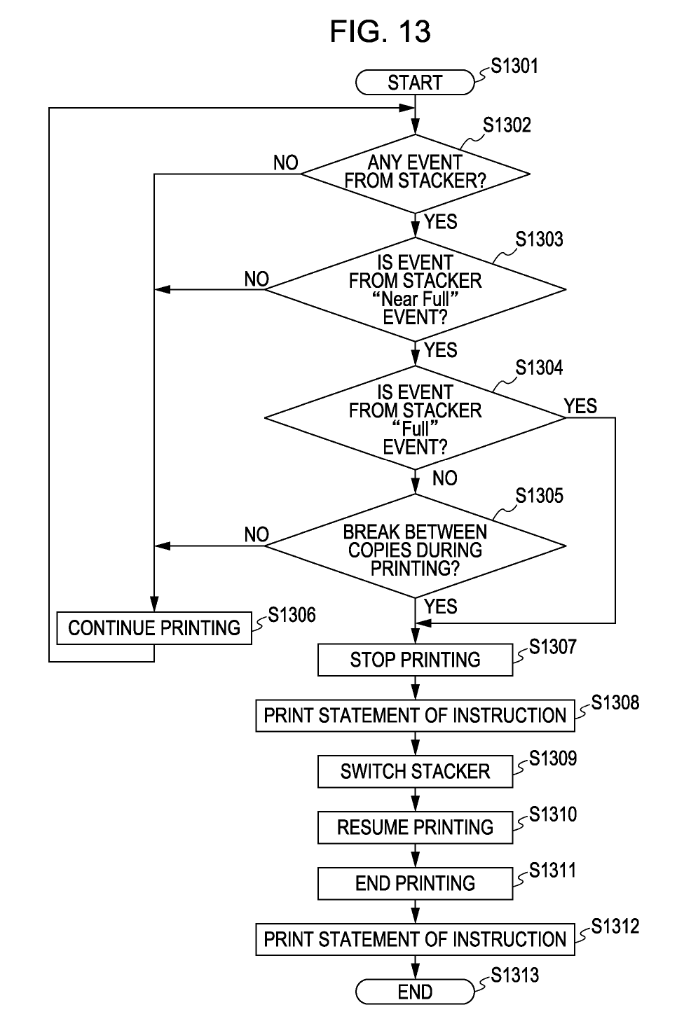

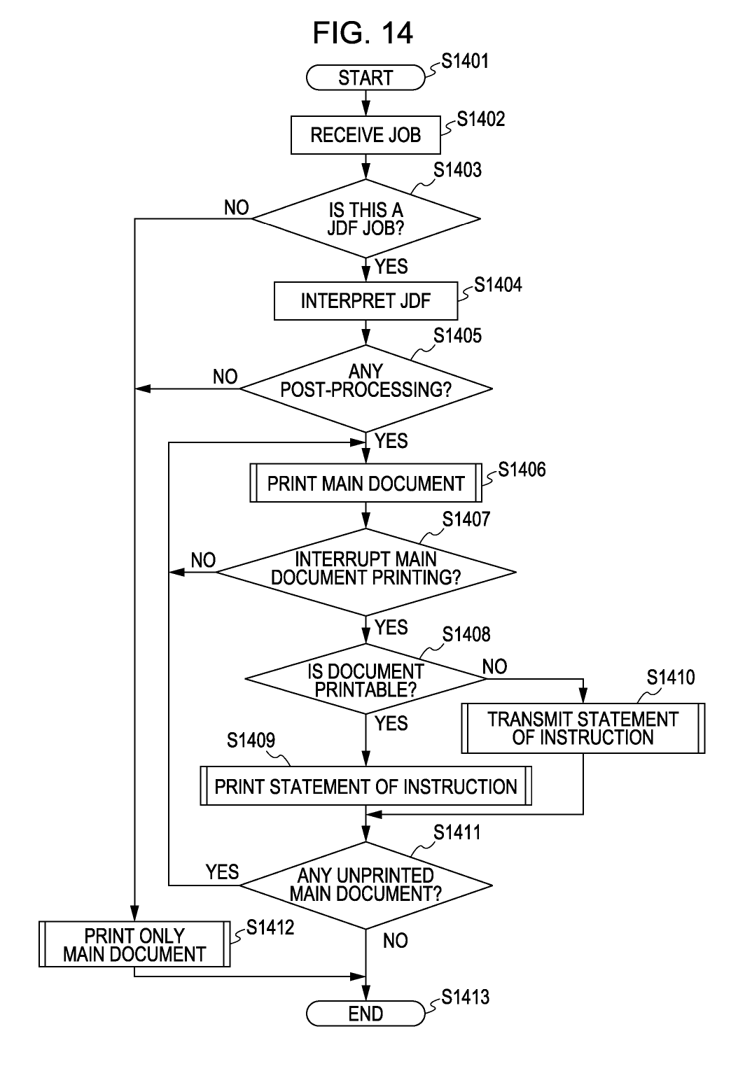

The determination of the steps S1203, S1205, S1207, and S1209 in FIG. 12 to be described later is of this specific example. Also, the determination of the steps S1302, S1303, S1304, and S1305 in FIG. 13 to be described later is of this specific example. Also, the determination of the steps S1403, S1405, S1407, S1408, and S1411 in FIG. 14 to be described later is of this specific example.

With the present embodiment, a statement of instruction may be a first type of statement of instruction or a second type of statement of instruction. The first type of statement of instruction is a statement of instruction wherein post-processing information is described that can distinguish the work content for the post-processing that is performed all at once as to multiple printing materials. The second type of statement of instruction is a statement of instruction wherein post-processing information is described that can distinguish the work content for the post-processing that is performed as to a portion of the printed material.

The controller 2100 enables a first type of statement of instruction describing operation and a second type of statement of instruction describing operation which is distinguished from the first type of statement of instruction to be selectively executed with a user interface for example. Also, the controller 2100 also functions as a unit to enable specifying whether to execute the first type of statement of instruction describing operation or the second type of statement of instruction describing operation beforehand by the operator using the user interface.

Also, the controller 2100 enables the first type of statement of instruction describing operation under the condition that a cause for printing interruption does not occur during the printing period for the multiple printing materials. Also, the controller 2100 enables the second type of statement of instruction describing operation under the condition that a cause for printing interruption occurs during the creating period for the multiple printing materials.

Also, in the case of executing the second type of statement of instruction describing operation, the controller 2100 outputs one sheet of a statement of instruction at the point in time that one copy of printed material of the multiple copies of printed materials is created, and also one sheet of the statement of instruction is output at the point in time that the remaining printed material is created. As the second type of statement of instruction, a statement of instruction wherein post-processing information is described that can distinguish the work content for the post-processing that is performed as to a portion of the printed material, and a statement of instruction wherein post-processing information is described that can distinguish the work content for the post-processing that is performed as to the remainder of the printed material, are output.

Also, in the case that a request for outputting a statement of instruction each time a specified number of copies worth of printed material of the multiple printed materials is printed is performed via the user interface, the controller 2100 does not execute the first type of statement of instruction describing operation, but rather enables execution of the second type of instruction describing operation.

Note that the printing system according to the present embodiment has a unit that functions as a receiving unit to receive determination material data for the statement of instruction printing timing necessary to determine the printing timing of the statement of instruction, via the user interface from the operator. For example, the operating unit 2104 of the present embodiment functions as an example of the unit herein.

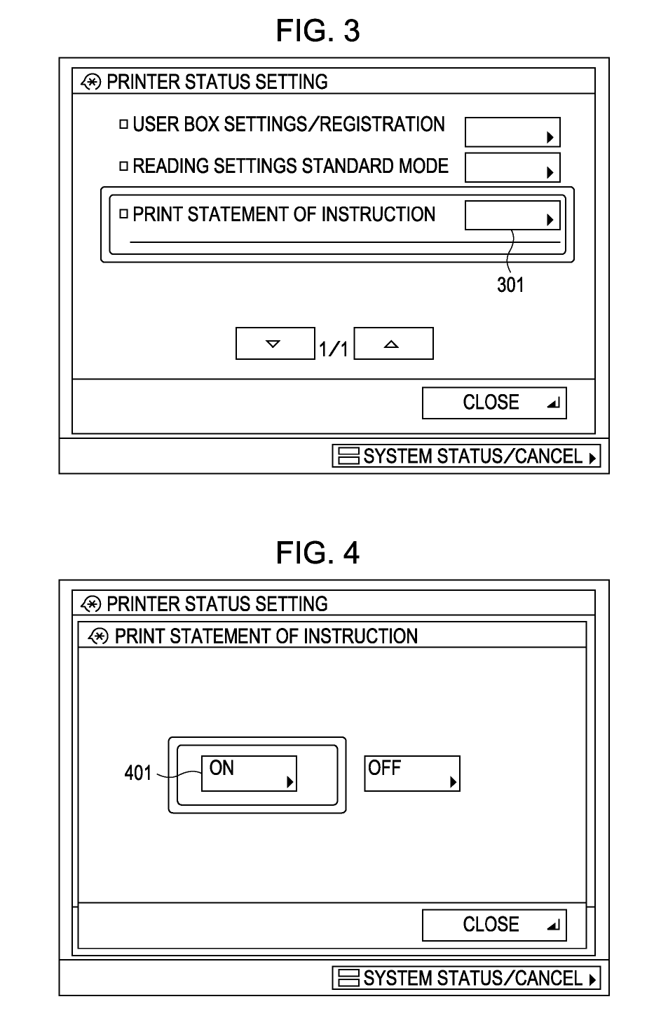

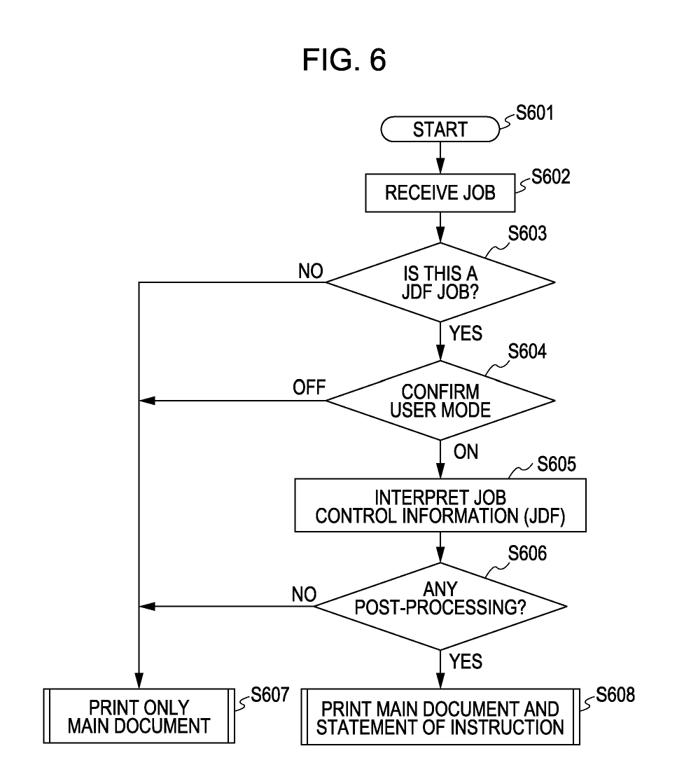

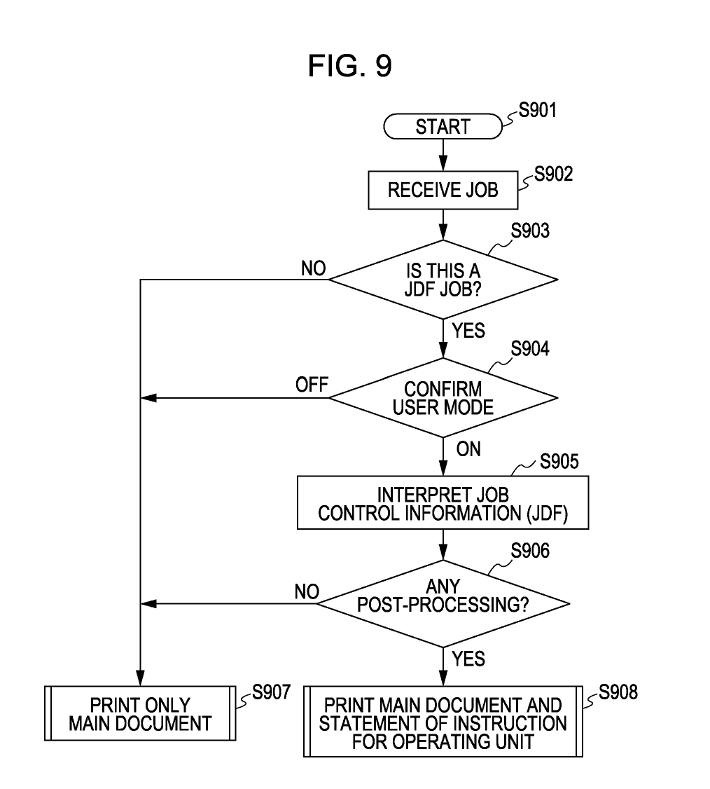

Also, an external data interface such as the network unit 2101 necessary in the case of receiving a printing job from the outside, such as the later-described step S602 in FIG. 6, step S902 in FIG. 9, step S1202 in FIG. 12, step S1302 in FIG. 13, S1402 in FIG. 14 and so forth, is also an example to function as such unit. Also, the user interface screens shown in the later described FIGS. 3, 4, 7, 10, and 11 are also specific examples of the user interface.

Let us say that, through the data receiving processing and determining processing, the controller 2100 determines that the printer unit 2200 has started printing of the printed material, and the timing has arrived to output a statement of instruction for the printed material that is printed. In this case, the controller 2100 describes a statement of instruction with a describing unit, and outputs the statement of instruction from the printer unit 2200. Note that the timing to describe the statement of instruction is not limited to this, and in the case that the output timing is known in advance, for example, an arrangement may be made wherein this is described in the statement of instruction beforehand and output is performed according to the timing therein.

Note that with a later-described specific example, a configuration functioning as a unit for the user interface which has a display function to output the statement of instruction described with the describing unit (outputting unit) is exemplified, such as the printer unit 2200 or operating unit 2104. Also, configurations to transfer the processing to the later-described step S607 in FIG. 6, step S907 in FIG. 9, step S1206 or S1210 in FIG. 12, step S1306 or S1310 in FIG. 13, and step S1406 or S1412 in FIG. 14, and print only the main document, are each specific examples of the control herein.

On the other hand, let us say that the controller 2100 has determined that, through the above-described data receiving processing and determining processing, the timing has arrived to output the statement of instruction for the printed material printed with the printer unit 2200. In this case, the controller 2100 performs control so as to enable the statement of instruction wherein information is described relating to post-processing performed as to the printed material, along with the creation of the printed material by the printer unit 2200, is output by the above-described outputting unit.

The control to transfer processing to the later-described step S608 in FIG. 6, step S908 in FIG. 9, step S1208 in FIG. 12, step S1308 or S1310 in FIG. 13, and step S1409 or S1410 in FIG. 14 and output the statement of instruction along with the creation of a main document are each specific examples of the control herein. Now, outputting a statement of instruction along with the main document (printed material) means to output a statement of instruction wherein information relating to post-processing performed for the printed material to be printed is described, at a predetermined timing.

Thus, with the present embodiment, the controller 2100 also functions as a unit to control the describing and output of the statement of instruction to describe the information relating to the post-processing as to the printed material performed by one of the above-described 3 types of finishers.

Thus, according to the printing system of the present embodiment, an arrangement can be provided which addresses the problem stated as the user being unable to obtain a statement of instruction when the statement of instruction is necessary. Also, for example, even in a case wherein the statement of instruction cannot be printed because of problems with the printing apparatus, an arrangement can be provided to output a statement of instruction with alternate formats such as facsimile or electronic mail. Thus, an arrangement that contributes to the realization of products which enable the output of statement of instructions can be provided with the printing system of the present embodiment.

Also, the controller 2100 that functions as the control unit causes the statement of instruction to be created by the outputting unit at the timing specified by the user, during printing of the printed material of the job to be processed by the printer unit 2200. With this control, the controller 2100 monitors the printing status of the printed material of the job requiring output of the statement of instruction, based on the information from the printer unit 2200. With such a configuration, a statement of instruction corresponding to the printed material subjected to printing is described, and the describing statement of instruction can be output.

Also, in the event that a problem occurs, a statement of instruction corresponding to the printed material printed up to the time of problem occurrence can be output. The printing system of the present embodiment is configured so that such advantages can be enjoyed as well.

Also, the printing system of the present embodiment is configured so that operator settings to instruct the output timing of the statement of instruction as to the image forming apparatus 102 can be performed by the operator beforehand via the user interface. With the present embodiment, the operating unit 2104 is used as the user interface. In the case determination is made that such settings are performed beforehand, the controller 2100 controls the information relating to the post-processing to be performed for the printed material, along with the printing of the printed material by the printer unit 2200, to be described by the a creating unit. The controller 2100 controls the described statement of instruction to enable being output by the above-described outputting unit.

Also, on the other hand of having the above-described configuration, the printing system of the present embodiment is configured so that operator settings to instruct output of the statement of instruction as to the job requiring printing of the printed material by the printer unit 2200 can also be performed by the operator via the user interface. Let us say that operator settings to instruct output of the statement of instruction as to the job requiring printing of the printed material are thus performed. In accordance with the determination thereof, the controller 2100 performs control to describe the statement of instruction for the job along with the creation of the printed material of the job by the printer unit 2200 with the above-described describing unit, and output with the outputting unit. Note that hereafter, the processing to describe the statement of instruction with the describing unit and to output the described statement of instruction with the outputting unit will be described as creating the statement of instruction with the creating unit.

Note that as a user interface provided as to an operator, for the controller 2100 to thus perform control relating to the describing and output of the statement of instruction, the operating unit 2104 is exemplified in the present embodiment, but should not be limited to this. For example, an operating unit such as a monitor or pointing device that the client PC 101 has, which equates to an example of another apparatus which can communicate data between the image forming apparatus 102 and the network, is also applicable as the user interface herein.

In this case, the user interface screen such as in the later-described FIGS. 3, 4, 7, 11, and 16 is controlled by the CPU of the other apparatus, so as to be displayable by a display unit thereof. Thus, the above-described determination material data as to whether or not the statement of instruction is needed can be received using the user interface of the other apparatus, thereby enabling realizing a configuration corresponding to later-described various types of configurations with the other apparatus. The printing system of the present embodiment is also applicable with such a configuration. Further, an arrangement may be made wherein an external apparatus such as the client PC 101 for example performs the describing of the statement of instruction, and the image forming apparatus 102 outputs the described statement of instruction.

Also, according to the present embodiment, the network unit 2101 is configured as follows. The network unit 2101 is configured so as to be able to receive identified types of jobs, wherein the instruction content relating to printing processing or post-processing is defined with an identified file format, as printing jobs input from an information processing apparatus such as the client PC 101.

Note that the printing system of the present embodiment is configured so that a job wherein the instruction content relating to printing processing or post-processing is not defined with the identified file format can also be received via a document reading unit (unshown) of the network unit 2101 and/or image forming apparatus 102. Let us say that the job requiring printing of printed material by the printer unit 2200 is such an identified type of job. In the case such determination is made, the controller 2100 performs control so that the statement of instruction for the job can be created by the creating unit along with the printing of the printed material of such job with the printer unit 2200.

On the other hand, let us say that the job requiring printing of printed material by the printer unit 2200 is the type of job that is not relevant to the identified types of jobs. In the case determination is made that this is relevant, the controller 2100 performs control so that printed material of the job can be printed with the printer unit 2200 without a statement of instruction for such job being created by the above-described creating unit.

The control based on determinations such as the later-describes step S903 in FIG. 9, step S1203 in FIG. 12, step S1303 in FIG. 13, and step S1403 in FIG. 14 are each specific examples of the configuration herein.

Note that a job wherein instruction content is defined with the identified file format means a JDF job with the present embodiment. On the other hand, a job wherein instruction content is not defined with the identified file format means a printing job of a different type than the JDF job (non-JDF job). For example, a PDL (Page Description Language) job that is subject to transmission from the information processing apparatus such as the client PC 101 is an example of a non-JDF job. Also, a copy job wherein printed data that is subject to printing processing is input from the above-described document reading unit is an example of a non-JDF job.

JDF is an abbreviation for Job Definition Format, which is a format defined by CIP4, and is a common digital format that is related to overall printing processes applicable to the POD printing system such as in FIG. 1. CIP4 is an abbreviation for Cooperation for the Integration of Processes in Prepress, Press and Postpress. For a JDF format, XML language which can also be used as a Web format is used. By configuring a device to enable processing of a JDF format job such as with the image forming apparatus 102 of the present embodiment, managing related to the overall printing processes can be performed on a Web site, such as generating managing, and confirming operation status of various devices such as printers and post-processing apparatuses.

Note that the JDF job can define instruction content relating to a series of work processing performed by multiple types of devices working in cooperation, and not only processing performed by one device from the document input process of the printing data necessary for creating printed material to serve as the final product to the transporting process of printed material. With a configuration such as the image forming apparatus 102 of the present embodiment enabling receiving the JDF job as a print job, management of a workflow series made up of multiple processes can be performed. Also, this can contribute to the coordination of multiple devices related to the overall printing process or automation of various types of devices.

With a background such as described above, the printing system of the present embodiment is configured so that control can be performed wherein the printing system of the present embodiment takes advantage of the JDF job as described above, so that the printing system can be utilized as a printing system for a POD market, not only for an office environment.

For example, the image forming apparatus 102 of the present embodiment has a JDF job receiving unit that receives a JDF job equating to identified types of print jobs wherein XML language that equates to an identified type of markup language is used. Also, the image forming apparatus 102 also has a JDF analysis unit that analyzes various types of information defined by using the XML language with the received JDF job. Such configurations are examples of the arrangement that realizes control utilizing the above-described features unique to JDF.

Note that with the present embodiment, the controller 2100 functions as the JDF job receiving unit and JDF job analysis unit, but the configuration within the apparatus associated thereto is not particularly limited, and various modifications and applications can be made.

For example, the network unit 2101 in FIG. 2 functions as the JDF job receiving unit, and the job control information control unit 2105 functions as the JDF job analysis unit that interprets the information defined with the JDF job. The CPU of the job control unit 2103 functions as the control unit.

Thus, if the printing system and printing apparatus have a unit to realize the various types of configurations described with the present embodiment, the present invention can be applicable with any internal configuration.

Also, with the present embodiment, the information showing specific instruction content such as the post-processing defined with the JDF job subject to reception by the image forming apparatus 102 can be interpreted with the image forming apparatus 102. Also, the information can be interpreted not only with the image forming apparatus 102, but also can be interpreted with the client PC 101 and near line finisher 103. Thus, the JDF job subject to analysis with the image forming apparatus 102 has information packaged that does not depend on the identified type of device.

For example, by interpreting the content described with XML language that equates to one of the markup languages packed in the JDF job, various types of information can be mutually confirmed with various types of devices. Also, the client PC 101 and near line finisher 103 can perform data communication with the image forming apparatus 102 via the network.

Thus, by using the JDF features, the various devices existing on the POD printing system in FIG. 1 are configured such that the information relating to post-processing described in the statement of instruction that is created by the above-described creating unit can be mutually sent/received via a transmission unit as described above.

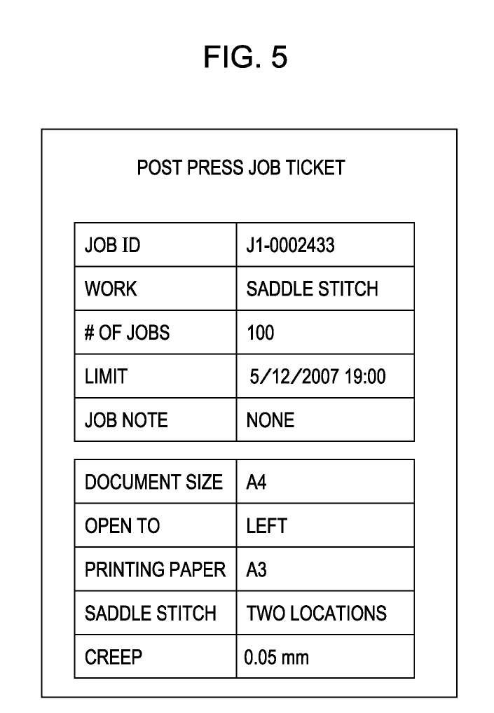

Also, as in the statement of instruction in FIG. 5, the printing system of the present embodiment is configured such that information relating to post-processing performed for the printed material created with the printer unit 2200 can be described in the statement of instruction in an output format that a human (operator) can visibly interpret.

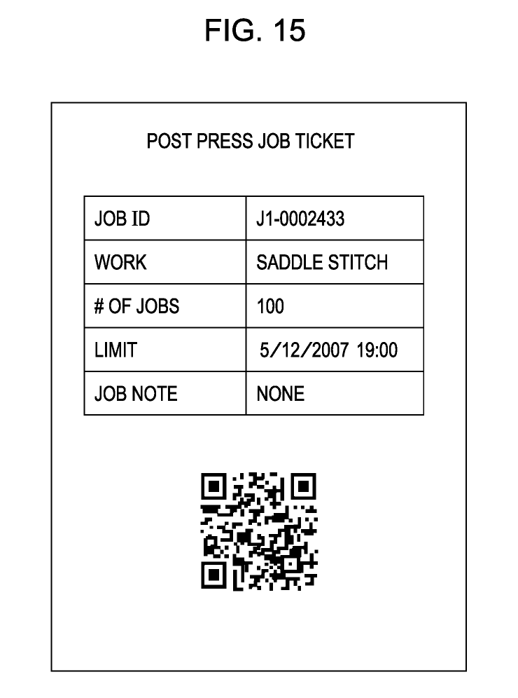

Further, the printing system of the present embodiment is configured so as to enable creating a statement of instruction as shown in FIG. 15 as well. That is to say, as with the QR code which is an example of a two-dimensional bar code described in the statement of instruction in FIG. 15, information relating to post-processing performed for the printed material printed with the printer unit 2200 is configured so as to be describable in the statement of instruction in an output format that a machine can interpret.

Note that the near line finisher 103 and offline finisher 104 in FIG. 1 have a bar code reader (unshown) that functions as an information reading unit wherein the two-dimensional bar code described in the statement of instruction in FIG. 15 can be read.

With these devices, the two-dimensional bar code on the statement of instruction in FIG. 15 can be read using the unit thereof. With these devices, based on the reading results thereof, the type of post-processing to be performed as to the printed material created with the printer unit 2200 along with the creation of the statement of instruction is determined. Upon the type thereof being identified, the devices herein can operate so as to perform the post-processing for the printed material. Providing such a configuration is desirable but not limited to this.

Also, as in the statement of instruction in FIG. 15 which can be created with the printing system of the present embodiment, a configuration is desirable wherein one output medium serving as one statement of instruction has information relating to the above-described post processing described in an output format that a human can recognize and also the information described in an output format that a machine can interpret. However, a configuration may be used wherein the statement of instruction can only be created with the format as shown in FIG. 5. Also, a configuration may be used wherein the information of the post-processing can only be output to the statement of instruction with the format that a device (computer) can read.

Note that the printing system of the present embodiment is configured such that the output format of the information relating to the post-processing described in the statement of instruction can be selected by the operator from the multiple selection candidates. For example, the controller 2100 displays a user interface screen including 3 types of selection options on the above-described user interface.

The 3 selection options have, first, a first selection option that corresponds to instructions described in the statement of instruction in an output format wherein the information can only be interpreted by a human. Next, the second selection option corresponds to instructions wherein the information is described in an output format that can only be interpreted by a machine. The remaining third selection option corresponds to instructions wherein the information is described in an output format that can be interpreted by both human and machine.

The above-described creating unit is controlled by the controller 2100 so that the information relating to the post-processing document is described in the statement of instruction with an output format corresponding to the selection option selected with the screen herein by the operator. The printing system according to an embodiment of the present invention preferably has such a configuration, but is not restricted to such.

Also, with the present embodiment the controller 2100 determines whether or not the job requiring creation of printed material by the printer unit 2200 is a job requiring post-processing by the post-processing apparatus which has a printed material receiving unit that receives the printed material without intervening work by an operator. The above-described inline finisher that has a sheet transporting path and processing tray for guiding the printed material transported from the printer unit 2200 into the device is a specific example of this post-processing apparatus.

Let us say that determination is made that the job to be processed is a job requiring post processing with the inline finisher (an inline finisher job). In this case, the controller 2100 performs control such that the printed material of the job can be created with the printer unit 2200 without a statement of instruction for the job being created with the above-described creating unit.

The inline finisher job is a job that does not require transporting work of the printed material by an operator in advance of performing post-processing for the printed material printed with the printer unit 2200. Thus, let us say that a job requiring printing of printed material with the printer unit 2200 is a job not requiring transporting work of the printed material by an operator in advance of performing post-processing for the printed material. With the present embodiment, in the case this determination is made, the controller 2100 performs control that the statement of instruction for the job is not created by the above-described creating unit, along with the creation of the printed material for the job.

Conversely, a job that performs post-processing for the printed material printed with the printer unit 2200 by the offline finisher 104 or the near line finisher 103 is a job requiring transporting work of the printed material by an operator in advance of performing post-processing for the printed material.

Let us say that the job requiring printing of the printed material with the printer unit 2200 is such a job requiring transporting work of the printed material by an operator in advance of performing post-processing for the printed material. With the present embodiment, in the case this determination is made, the controller 2100 performs control so that the statement of instruction for the job can be created with the above-described creating unit, along with the printing of the printed material of the job.

Note that a job requiring post-processing with the offline finisher 104 of the printed material printed with the printer unit 2200 is called an offline finisher job. Also, a job requiring post-processing with the near line finisher 103 of the printed material printed with the printer unit 2200 is called a near line finisher job. The jobs herein are jobs of a different type from the inline finisher job.

The near line finisher job with the present embodiment is an example of a job requiring post-processing by a post-processing apparatus that does not have a printed material receiving unit to receive printed material printed with the printer unit without intervening work by an operator, but does have a communication unit to communicate data with another apparatus.

Let us say that a job requiring printing of the printed material by the printer unit 2200 is a job requiring post-processing with a post-processing apparatus having such a configuration, as with this near line finisher. In the case that such a determination is made, the controller 2100 performs control so that an operator can select whether or not to create a statement of instruction for the job along with the creation of the printed material of the job with the above-described creating unit, via the above-described user interface.

With this control, for example, post-processing content is instructed to the near line finisher 103 via the network in FIG. 1, whereby cases that the creation of a statement of instruction by the image forming apparatus 102 is unnecessary can be handled. In this case, the operator instructs information to the effect that creation of the statement of instruction for the relevant job is unnecessary to the controller 2100 via the user interface. The controller 2100 receives this and causes the printer unit 2200 to print the printed material for the job, but performs control so that the statement of instruction for the job is not created by the above-described creating unit. Thus, the problem wherein a statement of instruction is needlessly created regardless of the operator desire can be suppressed, thereby further improving the above-described advantages thereof. Thus, the printing system of the present embodiment is configured so as to take advantage of such advantages by providing a configuration with consideration for a near line finisher and JDF.

Note that with the present embodiment, in accordance with the job to be processed being an inline finisher job, the controller 2100 inhibits the creation of a statement of instruction of the job along with the printing of the printed material of the job. On the other hand, in accordance with the job to be processed being an offline finisher job, the controller 2100 allows the creation of a statement of instruction of the job along with the creation of the printed material of the job.

Further yet, in accordance with the job to be processed being an inline finisher job, the controller 2100 performs control so that the operator can select, via the user interface, whether or not to create a statement of instruction of the job along with the printing of the printed material of the job. In order to improve the above-described advantage, having such a configuration, such as the printing system of the present embodiment, is desirable but is not limited to this.

Note that with the present embodiment, in the case that the post-processing apparatus to perform the post-processing for the printed material printed with the printer unit 2200 is changed, the controller 2100 performs control so that the statement of instruction wherein information reflecting the changed content is described can be created with the creating unit. Thus, an operator change request such as the creation of a statement of instruction is desired but a post-processing apparatus different from the originally planned post-processing apparatus should be used, and can be flexibly and appropriately handled. The configuration relating to step S1411 in FIG. 14 to be described later is a specific example of such control.

Also, as described with reference to FIG. 5, in the case of creating a statement of instruction, control is performed as follows. The controller 2100 performs control so that a statement of instruction wherein information visible to an operator, serving as information relating to the post-processing performed for the printed material printed with the printer unit 2200, is described can be created with the above-described creating unit.

Also, as described with reference to FIG. 15, the controller 2100 performs control so that a statement of instruction, wherein information that can be interpreted with an apparatus necessary for performing such post-processing is described, serving as information described in the statement of instruction, is created with the creating unit. Note that as such an apparatus, with the above description, an offline finisher 104 or near line finisher 103 having a bar code reader that can read a QR code is exemplified as a specific example, but an apparatus other than these may be used.

Also, as described above, the controller 2100 according to the present embodiment receives operating instructions relating to whether to describe information visible to the operator in the statement of instruction or describing information that can be interpreted by such an apparatus, via the above-described user interface. The controller 2100 then performs control for creating a statement of instruction by the above-described creating unit so that information relating to the post-processing can be described in the statement of instruction in a format corresponding to the operator instructions thereof. An arrangement may be made with such a configuration but another configuration may be used.

For example, let us say that the offline finisher 104 does not have the above-described bar code reader. This information is registered by the operator as registration information via the above-described user interface in the storage apparatus 2102, as device configuration information of the offline finisher 104.

On the other hand, let us say that the near line finisher 103 has the above-described bar code reader. This information is then registered by the operator as registration information via the above-described user interface in the storage apparatus 2102, as device configuration information of the near line finisher 103. Alternatively, the controller 2100 automatically obtains the information from the near line finisher 103 and registers this in the storage apparatus 2102 via the network.

Let us say that the controller 2100 makes a determination that the finisher performing post-processing for the printed material of the job to be processed is the offline finisher 104 that does not have a bar code reader, by referencing the job processing conditions. In this event, the controller 2100 reads and references the device configuration information of the offline finisher 104 from the storage apparatus 2102. In this case, in the event of creating a statement of instruction for this job, the controller 2100 performs control to enable automatically creating a statement of instruction in the format shown in FIG. 5, based on the information herein.

On the other hand, let us say that the controller 2100 makes a determination that the finisher performing post-processing for the printed material of the job to be processed is the near line finisher 103 that has a bar code reader, by referencing the job processing conditions. In this event, the controller 2100 reads and references the device configuration information of the near line finisher 103 from the storage apparatus 2102. In this case, in the event of creating a statement of instruction for this job, the controller 2100 performs control to enable automatically creating a statement of instruction in the format shown in FIG. 15, based on the information herein.

Thus, an arrangement may be made so that the information described in the statement of instruction can be determined as follows as to whether to describe information visible by the operator or whether to describe information that can be interpreted by the apparatus. An arrangement may also be made so that determination can be made automatically, based on the information of the post-processing apparatus that performs post-processing for the printed material printed by the printer unit 2200.

Thus, the printing system of the present embodiment is configured so that determination of the expression format of the information relating to post-processing to be described in the statement of instruction can be made manually or automatically, but should not be limited to this configuration. For example, a configuration may be used having only one of these configurations. In any case, the configuration below being applicable, as with the printing system of the present embodiment, is desirable.

For example, let us say that the job to be processed by the image forming apparatus 102 is an offline job requiring post-processing by the offline finisher which does not have a bar code reader or the like and does not have a function to read the information described in the statement of instruction. In the case such a determination is made, the controller 2100 performs control in the event of creating a statement of instruction of the job along with creation of the printed material of the job so that information visible to the operator is described in the statement of instruction as information relating to the post-processing of the job.

On the other hand, let us say that the job to be processed by the image forming apparatus 102 is a near line job requiring post-processing by the near line finisher which has a bar code reader or the like and has a function to read the information described in the statement of instruction. In the case such a determination is made, the controller 2100 performs control in the event of creating a statement of instruction of the job along with creation of the printed material of the job so that information that can be read/interpreted by the near line finisher is described in the statement of instruction as information relating to the post-processing of the job.

Thus, the above-described advantages can be obtained, and also work efficiency relating to the post-processing with the job after printing the printed material with the image forming apparatus 102 can be further improved.

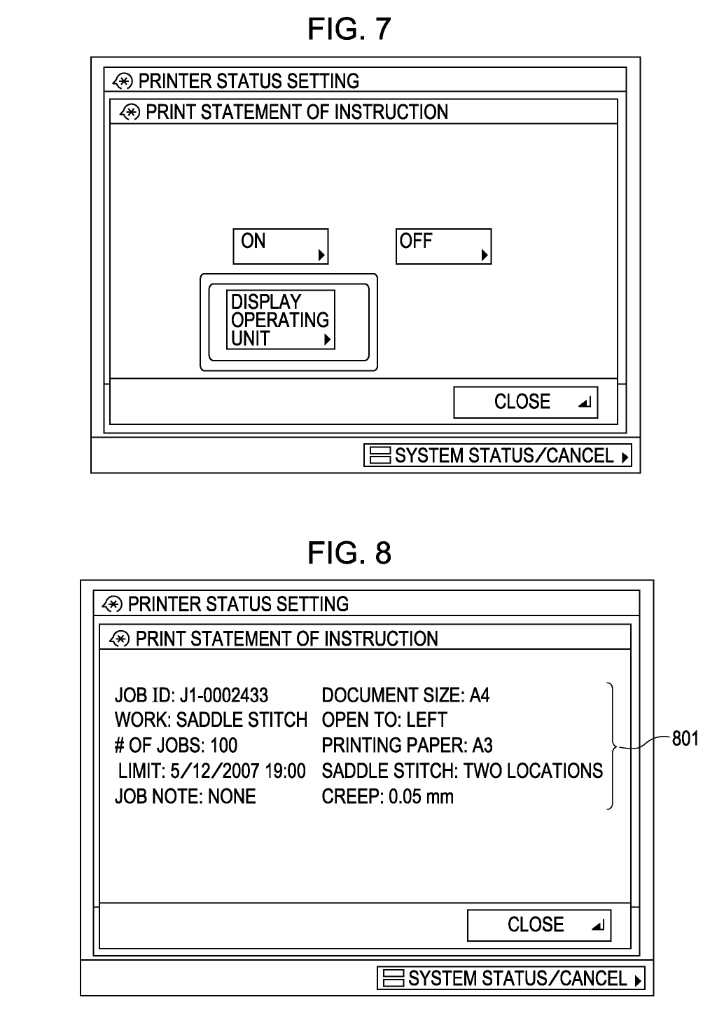

Note that as described above, the printing system of the present embodiment has a configuration wherein a display unit is employed as an outputting unit, and is a specific example wherein a user interface such as a monitor of the operating unit 2104 or client PC 101 functions as the display unit. Accordingly, to output the statement of instruction means to display the display material equating to a statement of instruction with such a display unit. A configuration relating to the user interface screen in the later-described FIGS. 7 or 8 or relating to step S908 in FIG. 9 are specific examples thereof. However, the applicable range of the present embodiment is not limited to these.

For example, as described above, the printing system of the present embodiment has a configuration wherein a printing unit is employed as an outputting unit, and the printer unit 2200 is a specific example that functions as such unit. Accordingly, to output a statement of instruction means to print the printed material for the statement of instruction with such a printing unit.

Also, for example, as described above, the printing system of the present embodiment also has a configuration wherein a transmission unit is employed as an outputting unit, and the printer unit 2200 is a specific example that functions as such unit. Accordingly, to output a statement of instruction means to use a unit to fax the statement of instruction, send by e-mail, transmit by I-fax, store on a server, save in a box, and so forth.

Thus, an arrangement may be made to use a configuration to employ a printing unit, or a configuration to employ a transmission unit, or a configuration to employ a display unit, or a configuration having all of these such as the printing system of the present embodiment, as an outputting unit.

In the case of employing a printing unit as the outputting unit, having further functions as described below is desirable. For example, in the event of printing a statement of instruction along with printing the main document of the job to be processed with the printer unit 2200, the controller 2100 confirms the number of sheets to print and the number of copies to print. For example, as with a later-described specific example, upon ending the printing of a specified number of copies, control is performed such that determination can be made as to whether to print the statement of instruction, and in the case of printing, after every how many copies worth to print the statement of instruction, based on operator instructions from the user interface.

Note that every number of printed copies worth means that, for example, in the event of printing 10 copies of a 10-page printed material, a statement of instruction is printed for every number of copies specified by the operator, e.g. every 5 copies. Every number of printed sheets means to count one sheet of paper as a sheet and print a statement of instruction for every printed number of sheets specified.

Also, as a later-described specific example, the printing system of the present embodiment has a configuration wherein the operator himself can select with the user interface whether to print a statement of instruction every specified number of copies or to print a statement of instruction every specified number of sheets. This equates to a configuration wherein the printing of the statement of instruction is specified manually.

Also, as timing to perform printing of the statement of instruction, the controller 2100 confirms the amount of printing time passed. For example as a later-described specific example, control can be performed such that determination can be made whether to create the statement of instruction every amount of time passed, and in the case of creating, to print a statement of instruction every how many minutes, based on operator instructions from the user interface.

Also, as timing to perform printing of the statement of instruction, the controller 2100 has a configuration wherein the operator himself can select with the user interface whether or not to print the statement of instruction according to the occurrence of a printing interruption cause.

Note that a printing interruption cause may be a problem wherein, for example, the stacker which is the inline finisher has become full, whereby printing cannot be continued, or a paper jam has occurred, or consumables such as toner or paper have run out. Note that the controller 2100 monitors the state of the image forming unit 2200, and performs control to print the statement of instruction in accordance with the state thereof.

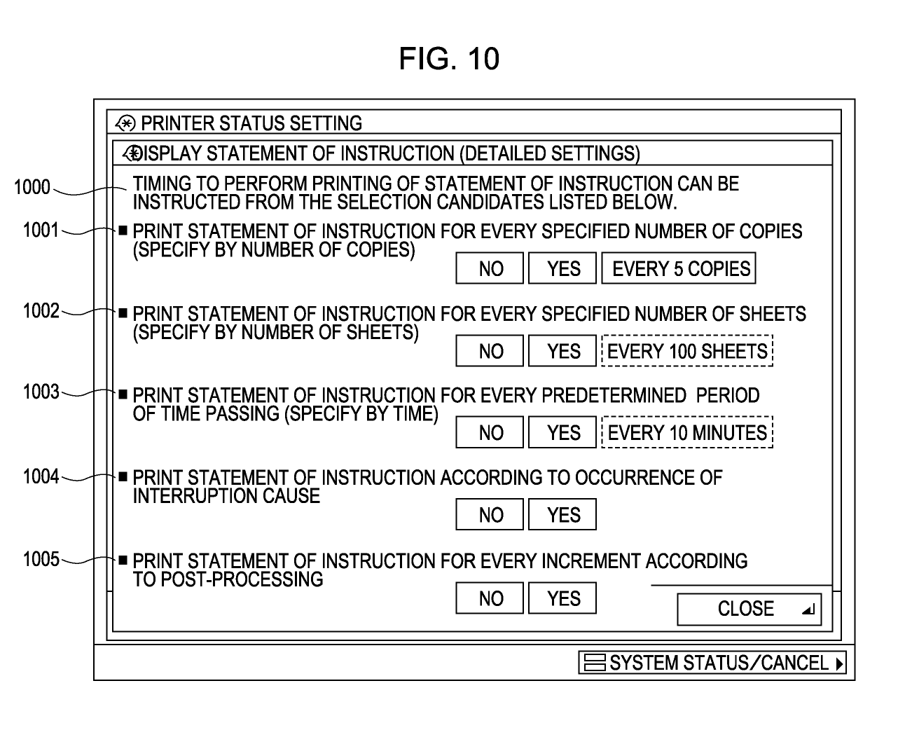

Thus, with the present embodiment the controller 2100 controls the printing timing of the statement of instruction based on the operator instructions from the user interface so that the statement of instruction is created by the printer unit 2200. A configuration using the user interface in FIG. 10 as described later is a specific example of such a configuration.

Note that the printing system of the present embodiment takes the format to specify the timing to print the statement of instruction beforehand from the user interface, but should not be limited to this. An arrangement may be made with a configuration wherein a confirmation screen is shown to the operator for each printing timing of each statement of instruction, to confirm whether or not to print, and the statement of instruction is printed after confirmation is made. For example, in the event of printing a statement of instruction along with printing the main document of the job to be processed with the printer unit 2200, the controller 2100 confirms the state of the printer unit 2200.

For example, as with a later-described specific example, in a state wherein printing cannot be performed due to a paper jam or lack of toner, control is performed as follows. Control is performed to determine whether to transmit the statement of instruction by e-mail, or transmit by fax, or transmit by I-fax, or save on the file server, or stored in a box, based on operator instructions from the user interface.

Note that e-mail, fax, and I-fax transmissions mean processing to transmit the created statement of instruction to the transmission address specified by the operator, and performing the necessary transmission processing thereof. Saving on a file server and storing in a box mean processing to save the created statement of instruction in a saving location specified by the operator, and performing the necessary saving processing thereof.

Also, as with a later-described specific example, the printing system of the present embodiment has the following configuration. The printing system has a configuration wherein, at a time that the statement of instruction cannot be printed, the operator himself can select, with the user interface, whether to wait until the printing can be restarted, whether to transmit the statement of instruction by e-email, or transmit by fax, or transmit by I-fax, or save on the file server, or stored in a box.

As described above, the printing system of the present embodiment may have a configuration to actualize various types of control relating to the creation of the statement of instruction, but an arrangement may be used wherein the configuration has all of these, or an arrangement may be used wherein the configuration has only one of these. For example, any configuration may be employed as long as at least one of the above-described advantages can be obtained with the configuration.

Also, with the above-described various types of configurations and later-described specific example, a configuration is employed wherein the controller 2100, belonging to the image forming apparatus 102 which has the printer unit 2200, functions as the control unit, but should not be limited to this. For example, a configuration may be used wherein various types of control relating to the creation of the statement of instruction described with the present embodiment are realized with a CPU provided on an external apparatus that can perform data communication with the image forming apparatus 102. Note that the client PC 101 and near line finisher 103 in FIG. 1 equate to an example of such an external apparatus.

Thus, the printing system of the present embodiment may be configured so as to be applicable to a configuration having a control unit on an external apparatus that differs from the image forming apparatus 102.

Next, a specific example of control relating to the creation of the statement of instruction of the above-described present embodiment will be described in sequence. Note that the configuration other than the configuration described with the specific example below is the same as the above-described configuration, so this point will be omitted from the description.

Also, with the specific example below, a configuration is exemplified wherein the controller 2100 performs control so that the various types of user interface screens shown in FIGS. 3, 4, 7, 8, 10, and 11 are displayed on the operating unit 2104, but should not be limited to this. For example, as described above, an arrangement may be made wherein the configuration can provide the same screens as these on the user interface of the external apparatus such as the client PC 101.

Also, with the later-described specific example, the CPU of the controller 2100 reads and executes a computer-readable program for executing the processing in each of the flowcharts in FIGS. 6, 9, 12, 13, and 14 from the memory within the image forming apparatus 102. The processing herein is thus executed. Such a configuration is exemplified but should not be limited to this. For example, as described above, an arrangement may be made with a configuration wherein such processing is executed with the CPU of the external apparatus such as the client PC 101.

### SPECIFIC EXAMPLE 1

The first specific example will be described. FIG. 3 is a screen that is displayed on the operating unit 2104 and that the user sets printing settings, and shows the portions that particularly relate to the printing of the statement of instruction. FIG. 4 is a screen displayed on the operating unit 2104 in the event that a “print statement of instruction” button 301 is pressed on the screen shown in FIG. 3. That is to say, this is a screen for the user to perform settings as to whether printing of the statement of instruction will be performed or not. FIG. 5 is an example of the statement of instruction printed by the image forming apparatus 102 with a configuration of the various embodiments described below. How to use the statement of instruction herein will be described below.

For example, by the operator visibly confirming the content of the statement of instruction in FIG. 5, the operator can understand the instruction content for the post-processing as to the printed material of the job to be processed according to the statement of instruction herein. In the example in FIG. 5, text information is printed on the statement of instruction so that the operator can view the specific instruction content so as to execute saddle-stitch binding as to the printed material of the job.

In accordance with the instruction content of the statement of instruction, the operator removes the printed material of the job from the ejecting unit of the image forming apparatus, and transports the printed material to a location wherein the post-processing apparatus is disposed that is identified by the instruction content of the statement of instruction. For example, the operator transports the printed material of the job to the offline finisher 104.

The operator sets the post-processing conditions based on the instruction content described in the statement of instruction for the job thereof, with the operating unit of the offline finisher 104. Thus, the offline finisher 104 executes saddle-stitch binding as to the printed material of the job. Thus, processing necessary for the job is completed, and the finished product is created.

Next, a printing method for the printed material main document and statement of instruction will be described with reference to the flowchart in FIG. 6. FIG. 6 is a flowchart showing a specific example of the control relating to the creation of the statement of instruction. In FIG. 6, first, the main processing is started when the power is turned on for the image forming apparatus 102 (step S601). When the job is input from the job input source such as the client PC 101 in response to instructions by the user, the controller 2100 receives the job to be processed with the printing system (step S602). Next, the controller 2100 determines whether or not the job herein is a job that is expressed with a job ticket such as JDF (step S603).

In the case that the job is not expressed with a job ticket such as JDF, the controller 2100 inhibits printing of the statement of instruction along with the printing of the main document as processing for the job, and controls the printer unit 2200 so as to print only the main document (step S607). Thus, printing only the main document means to not print the statement of instruction, and means to create the printed material subject to post-processing, and means to print the printed data of the job as to printing paper which serves as the printed material.

If the job is expressed with a job ticket such as JDF, the controller 2100 performs control according to the user settings in FIG. 4. For example, if the user has set the setting of “OFF” which does not perform printing of the statement of instruction (“OFF” in step S604), the controller 2100 controls the printer unit 2200 such that only the main document for this job is printed (step S607).

If the user has set the setting of “ON” which performs printing of the statement of instruction (“ON” in step S604), the controller 2100 performs interpretation of the job control information such as JDF that is packaged in this job (also called job ticket information) (step S605). As a result of interpreting the job control information, if determination is not made that there is post-processing (NO in step S606), the controller 2100 performs the following control. Control is performed such that printing for only the main document is performed without outputting a statement of instruction along with the printing of the main document as the processing of this job (step S607). That is to say, the controller 2100 inhibits creating a statement of instruction for the job along with the printing of the main document (creation of the printed material), as processing for this job.

On the other hand, if determination is made that there is post-processing (YES in step S606), the flow is moved to step S608, and the controller 2100 performs the following control. As processing for this job, a statement of instruction is created for the job along with the printing of the main document (creation of the printed material) (creation of the statement of instruction is permitted).

For example, in step S608 the controller 2100 causes the printer unit 220 to execute printing of the printing data of the job (printing of the main document) packaged along with the above-described job ticket information, for the JDF job. Additionally, the controller 2100 causes the printer unit 2200 to create the statement of instruction wherein information relating to the post-processing defined in the XML of the job is described, along with the printing of the main document.

For example, based on the above-described job ticket information of the job, the printer unit 2200 is controlled to print the information relating to the post-processing to be performed as to the printed material that the printing of the main document performs (post-processing information), on the printing medium equating to the statement of instruction. Thus, the user can output the statement of instruction at the same time as the main document.

Also, FIG. 9 is a flowchart showing a specific example of control relating to the creation of a statement of instruction. Steps S901 through S907 in FIG. 9 are similar to steps S601 through S607 in FIG. 6, so the description thereof will be omitted. The point wherein FIG. 9 differs from FIG. 6 is the point in step S908 wherein the statement of instruction is displayed on the operating unit 2104 instead of printing the statement of instruction (see FIG. 8).

FIG. 10 is a screen for the user to set the printing status that is displayed on the operating unit 2104, and is a drawing showing the portions relating particularly to timing to print the statement of instruction. In FIG. 10, a message as to the operator (“the timing to perform printing of the statement of instruction can be specified from the selection candidates below”) 1000, and setting portions 1001 through 1005 for the operator to perform various types of settings, are displayed on the print status setting screen.

With the print status setting screen, whether or not to print a statement of instruction for every specified number of copies of printed material (“yes”, “no”) can be specified, and in the case of printing, printing a statement of instruction after every how many copies can also be specified from the setting portion 1001. For example, in the case of specifying to print a statement of instruction for every 100 copies in the event of printing 1000 copies of the printed material (create printed material worth the number of specified copies), the number of statement of instructions is 10.

Also, whether or not to print a statement of instruction for every specified number of sheets of printed material (“yes”, “no”) can be specified, and in the case of printing, printing a statement of instruction after every how many sheets can also be specified from the setting portion 1002. For example, in the case of specifying to print a statement of instruction for every 200 sheets in the event of printing 1000 sheets of the printed material, the number of statement of instructions is 5.

Also, whether or not to print a statement of instruction for every predetermined amount of time passing (“yes”, “no”) can be specified from the setting portion 1003. At the same time, after how many minutes to print each statement of instruction after the job starting can be specified. For example, in the case of specifying to print a statement of instruction every 10 minutes in the case of printing a predetermined number of copies or a predetermined number of sheets of the printed material, at the point in time that 20 minutes has passed after the start of printing, the number of statement of instructions is 2.

Also, whether or not to print a statement of instruction in accordance with an occurrence of interruption cause of printing (job) (“yes”, “no”) can be specified from the setting portion 1004. For example, in the case of specifying to print a statement of instruction at the time that the job is interrupted, in the case of printing 1000 copies of the printed material, in the case that the printing (job) is interrupted at the point in time that a certain number of copies have been printed (e.g. 640 copies), the number of statement of instructions at that point in time is 1. At the point in time that the remaining copies (360 copies) have ended printing, the number of statement of instructions at that point in time is 1.

Also, whether or not to print a statement of instruction in increments according to the post-processing (“yes”, “no”) can be specified from the setting portion. Upon the operator specifying to print a statement of instruction (“yes”), in the event of printing 1000 copies of printed material for example, in the case of specifying to print a statement of instruction at the point in time of performing post-processing (staple processing, punch processing, and so forth) for every 200 copies of printed material, the number of statement of instructions is 5.

That is to say, with the various types of settings shown in FIG. 10, one statement of instruction is created at the point in time that a portion of printed material from the multiple printed materials is created (each time a portion of printed material is created), and another statement of instruction is created at the point in time when the remaining printed material is created.

Next, a printing method for the statement of instruction will be described with reference to the flowchart in FIG. 12. FIG. 12 is a flowchart showing a specific example of control relating to the creation of a statement of instruction. In FIG. 12, first, the main processing is started when the power is turned on for the image forming apparatus 102 (step S1201). When the job is input from the job input source such as the client PC 101 in response to instructions by the user (step S1202), the controller 2100 performs the following determination. The controller 2100 determines whether or not the job input (received) is a job that is expressed with a job ticket for the job to be processed with the printing system (step S1203).

In the case that the job is not expressed with a job ticket such as JDF, the controller 2100 inhibits printing of the statement of instruction along with the printing of the main document as processing for the job, and controls the printer unit 2200 so as to print only the main document (step S1210), and ends the present processing (step S1211).

If the job is expressed with a job ticket such as JDF, the controller 2100 performs control according to the user settings on the screen in FIG. 4. For example, if the user has set the setting of “ON” 401 which performs printing of the statement of instruction, the controller 2100 performs interpretation of the job control information such as the JDF which is packaged in this job (step S1204).

As a result of interpreting the job control information, if determination is not made that there is post-processing (NO in step S1205), the controller 2100 controls the printer unit 220 to perform printing of only the main document, and not print the statement of instruction along therewith (step S1210). On the other hand, if determination is made that there is post-processing (YES in step S1205), the controller 2100 starts printing of the main document with the printer unit 2200 (step S1206).

Next, in the event of reaching the timing set by the operator in FIG. 10, the controller 2100 determines whether the state thereof is in a predetermined state (YES in step S1207). A predetermined state includes, for example, a state that printing has ended for the specified number of copies, a state that printing has ended for the specified number of sheets, a state that a specified amount of time has passed, a state that an interruption cause of some sort has occurred, a state that, printing has ended up to the limit value that, as a result of interpreting JDF, the post-processing apparatus can process, and so forth.

If in a predetermined state (YES in step S1207), the controller 2100 prints a statement of instruction with the printer unit 2200 following the current state (step S1208). Following this, if determination is made that printing for the main document is still remaining (YES in step S1209), the controller 2100 continues to print the main document with the printer unit 2200 (step S1206).

Next, printing of the statement of instruction according to the occurrence of an interruption cause will be described in detail with reference to the flowchart in FIG. 13.

FIG. 13 is a flowchart showing a specific example of control relating to the creation of the statement of instruction. In FIG. 13, first, the processing in the flowchart is started (step S1301) during printing of the main document (step S1206 in FIG. 12). The controller 2100 confirms whether or not there is an event from the stacker via the printer unit 2200 (step S1302). In the case that an event is not received, the controller 2100 continues printing with the printer unit 2200 without change (step S1306).

Upon receiving an event, the controller 2100 interprets the event thereof, and confirms whether an event called “Near Full”, wherein the stacker will soon become full, is received (step S1303). Next, the controller 2100 determines whether an event called “Full” is received from the stacker via the printer unit 2200 (step S1304).

In the case that a “Full” event is not received from the stacker (NO in step S1304), there is still room to output printed material in the stacker, whereby the controller 2100 continues to print with the printer unit 2200 until the end of a copy of the printed material (step S1305). Thereafter, the controller 2100 stops the printing of the main document (step S1307), and prints the statement of instruction according to the state at the point in time thereof with the printer unit 2200 (step S1308).

On the other hand, in the case that a “Full” event is received from the stacker (YES in step S1304), printed material can no longer be output in the stacker, whereby the controller 2100 immediately stops printing of the main document (step S1307). Further, the controller 2100 outputs a statement of instruction with the printer unit 2200 (step S1308).

Next, the controller 2100 switches the output destination from the stacker that has become full with printed material to a different stacker (step S1309), and restarts printing of the main document with the printer unit 2200 (step S1310). Subsequently, the controller 2100 continues printing with the printer unit 2200 until the printing of the main document has ended (step S1311), and upon printing ending, prints the remaining statement of instruction (step S1312), and ends the present processing (step S1313). Thus, the user can output a statement of instruction at a desired timing.

A second specific example will be described. With the second specific example, as a method to create the statement of instruction, a configuration wherein printing of the statement of instruction is not performed, but the statement of instruction is transmitted by fax, e-mail, or I-fax, or saved on a file server or stored in a box, will be described.

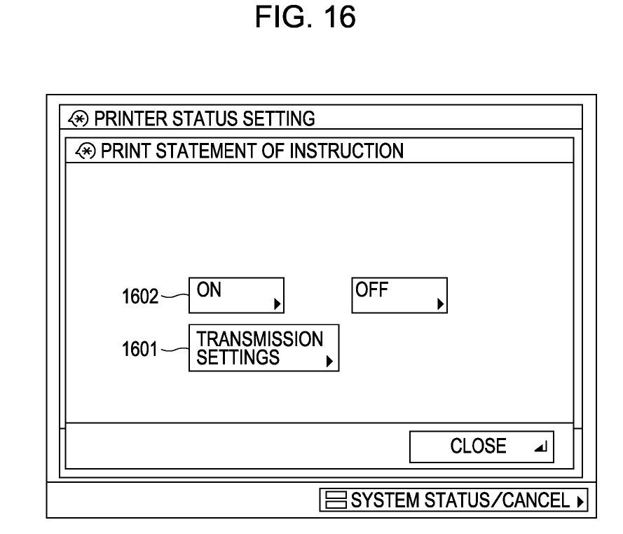

FIG. 16 shows a screen displayed on the operating unit 2104 in the event of pressing a “print statement of instruction” button 301 on the screen in FIG. 3. That is to say, this is a screen to perform setting of whether the user will perform printing of the statement of instruction, and whether or not to transmit the statement of instruction in the event that the statement of instruction cannot be printed for some reason.

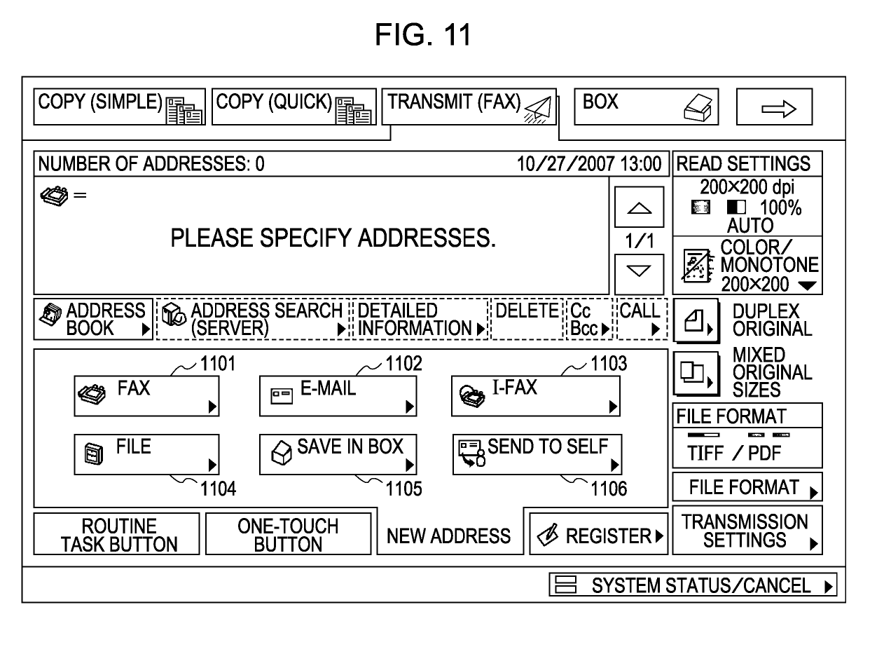

FIG. 11 shows a screen displayed on the operating unit 2104 in the event of pressing a “transmission settings” button 1601 on the screen in FIG. 16, or in step S1410 of FIG. 14. That is to say, this is a screen for the user to perform settings of where to transmit with what method, in the event of transmitting the statement of instruction. With this screen, a menu of transmission destinations (addresses) for the statement of instruction are displayed as “fax” 1101, “e-mail” 1102, “I-fax” 1103, “file” 1104, “store in box” 1105, and “send to self” 1106.

Next, a method for printing the printed material main document and statement of instruction and displaying the transmission UI (user interface) will be described with reference to the flowchart in FIG. 14. FIG. 14 is a flowchart showing a specific example of control relating to the creation of the statement of instruction. In FIG. 14, first, the present processing is started when the power is turned on for the image forming apparatus 102 (step S1401). When the job is input from the job input source such as the client PC 101 in response to instructions by the user (step S1402), the controller 2100 performs the following determination. The controller 2100 determines whether or not the job input (received) is a job that is expressed with a job ticket for the job to be processed with the printing system (step S1403).

In the case that the job is not expressed with a job ticket such as JDF, the controller 2100 inhibits printing of the statement of instruction along with the printing of the main document as processing for the job, and controls the printer unit 2200 so as to print only the main document (step S1412).

If the job is expressed with a job ticket such as JDF, the controller 2100 performs control according to the user settings on the screen in FIG. 16. For example, if the user has set the setting of “ON” 1602 which performs printing of the statement of instruction, the controller 2100 performs interpretation of the job control information such as the JDF which is packaged in this job (step S1404).

As a result of interpreting the job control information, if determination is not made that there is post-processing (NO in step S1405), the controller 2100 controls the printer unit 2200 to perform printing of only the main document, and not print the statement of instruction along therewith (step S1412). On the other hand, if determination is made that there is post-processing (YES in step S1405), the controller 2100 starts printing of the main document with the printer unit 2200 (step S1406).

Next, in the event of reaching the timing set by the operator in FIG. 10, the controller 2100 determines whether the state thereof is in a predetermined state (YES in step S1407). A predetermined state includes, for example, a state that printing has ended for the specified number of copies, a state that printing has ended for the specified number of sheets, a state that a specified amount of time has passed, a state that an interruption cause of some sort has occurred, a state that, printing has ended up to the limit value that, as a result of interpreting JDF, the post-processing apparatus can process, and so forth.

If in a predetermined state (YES in step S1407), the flow is moved to step S1408, and the controller 2100 determines whether or not printing can be continued (step S1408). In the particular case that printing can be continued, the controller 2100 prints a statement of instruction with the printer unit 2200 (step S1409). Whether or not printing can be continued means whether or not whether or not printing can be continued because a paper jam has occurred, or consumables such as toner or paper have run out.

In the case that such a problem has occurred and printing cannot be continued (NO in step S1408), the controller 2100 automatically transmits the transmission method specified beforehand and the statement of instruction as to the transmission destination (step S1410). Next, in the case that, upon resolution of the problem, there is still a main document for which printing has not yet ended (YES in step S1411), the controller 2100 continues printing with the printer unit 2200 (step S1406). In the case that printing of the main document has ended, the present processing is ended (step S1413).

A third specific example will be described. In the second specific example, the statement of instruction is transmitted in step S1410 in FIG. 14. Conversely, a UI of the statement of instruction may be displayed, as shown in FIG. 8. With the example of FIG. 8, as a display 801 of the statement of instruction, the display is shown as document size: A4, open to: left side, printing paper: A3, saddle-stitch: two locations, creep: 0.05 mm.

A fourth specific example will be described. In the second specific example, the timing for printing the statement of instruction shown with the first specific example is not specified with a user mode. Conversely, the timing for printing the statement of instruction as with the first specific example may be specified with a user mode.

A fifth specific example will be described. The controller 2100 also functions as a non-JDF job receiving unit to receive, not only the above-described JDF job, but also a non-JDF job wherein an identified type of markup language such as XML is not employed. For example, a PDL job, which a manufacturer of the image forming apparatus 102 uniquely provides, and which is subject to input from a printer driver unique to the manufacturer that can be installed in a client PC 101 or the like, is a specific example of a non-JDF job.

Also, a copy job wherein printing data is input, via user instructions from the operating unit 2104, from a document reading apparatus that the image forming apparatus 102 itself has, or a facsimile job subject to facsimile reception, are specific examples of a non-JDF job. Also, a storing job wherein data subject to printing is input from a predetermined storage unit such as a storage apparatus 2102 wherein a hard disk or the like is employed and/or an unshown removable media which is detachable from the image forming apparatus 102, is also a specific example of a non-JDF job.

With the series of processing in FIG. 6 as described above, let us say that the job that the image forming apparatus 102 receives from the client PC 101 as a printing execution request in step S602 is such a non-JDF job. In this case, the controller 2100 moves the flow from step S603 to step S607, and performs the above-described printing processing of the main document and statement of instruction in step S607 for the non-JDF job.

Similarly, with the series of processing in FIG. 9 as described above, let us say that the job that the image forming apparatus 102 receives from the client PC 101 as a printing execution request in step S902 is such a non-JDF job. In this case, the controller 2100 moves the flow from step S903 to step S907, and performs printing of the main document in step S907 and display processing of the statement of instruction on the operating unit 2104 for the non-JDF job.

Similarly with FIGS. 12 and 14, if the job that the image forming apparatus 102 has received from the client PC 101 as a printing execution request is a non-JDF job, the controller 2100 performs the following processing. That is to say, the controller 2100 makes the determination of NO for each of steps S1203 and S1403. The controller 2100 then performs the above-described processing of steps S1210 and S1412 for the non-JDF job.

Thus, the image forming apparatus 102 according to the present embodiment is configured so as to take advantage of the above-described various advantages, while also supporting the non-JDF job, and without problems such as new problems occurring because of a JDF job and non-JDF job co-existing.

The printing system according to the present embodiment including the above-described various specific examples is configured to be able to create a statement of instruction wherein information is described relating to post-processing performed as to the printed material of a job requiring creation of multiple printed material, with a creating unit (hereafter called output unit). Note that the image forming unit 2200 or a user interface such as a display unit may be employed as such output unit, as described above, but an arrangement other than this may also be employed. Also, as shown in the image forming unit 2200 of the present embodiment, employing a configuration wherein the function to create printed material and the function to create the statement of instruction are combined is not necessary, and a configuration may be employed wherein each function is realized with different units respectively.

With the present embodiment, an identified statement of instruction creating operation for creating the statement of instruction along with a portion of the printed material of the multiple printed materials being created with the image forming unit 2200, is controlled with the controller 2100 so as to be executed with the output unit. Also, in the case of executing the instruction document creating operation with the output unit, the controller 2100 performs control to create the statement of instruction, wherein information is described relating to performing post-processing as to a portion of the printed material, with the output unit.

Thus, the controller 2100 not only controls the timing to create the statement of instruction, but also controls the instruction content to be described in the statement of instruction so that the instruction content matches the timing for such creation. The configuration thereof is thus so that various types of later-described advantages can be obtained with various types of control relating to the statement of instruction creation performed by the controller 2100, including the above-described various types of control of the embodiment.

Note that with the present embodiment, description is given for a configuration wherein a statement of instruction is output, wherein information relating to the post-processing for the printed material is described, for each time a portion of the printed material is printed, but the output timing should not be limited to this. For example, an arrangement may be made with a configuration wherein upon multiple printed materials being printed, multiple statement of instructions corresponding to a portion of printed materials of the multiple printed materials are output. In the case of the above-described configuration, a configuration is desirable wherein a portion of printed materials of the multiple printed materials are ejected, each to different ejecting destinations, and the statement of instruction of the above-described portion of printed material is ejected to the ejecting destination wherein the printed material is ejected.

Further, the content described in the statement of instruction should not be limited to the content described with the present embodiment, and may be arranged with another configuration. The described content of the statement of instruction may be such as the specific examples shown below, for example.

FIG. 10 shows an example of a statement of instruction performing printing in step S1208 in FIG. 12, in the case of selecting “print statement of instruction for every specified number of copies” and “every 5 copies”. The portions in FIG. 15 showing “# of Jobs” and “100” which indicate the number of copies included in the job have content described according to the number of copies, such as
1-5/100 (1 through 5 copies out of 100 copies)
6-10/100 (6 through 10 copies out of 100 copies)
11-15/100 (11 through 15 copies out of 100 copies).

On the other hand, FIG. 10 shows an example of a statement of instruction performing printing in step S1208 in FIG. 12, in the case of selecting “print statement of instruction for every specified number of sheets” and “every 100 sheets”. In the case of performing 100 jobs wherein 1 job has 6 pages, if a statement of instruction is printed for every 100 sheets, the statement of instruction will be printed after the 16th job is finished at 96 sheets and the 4th page of the 17th job is output. An example of the statement of instruction printed in this event has “# of Jobs” in FIG. 15 changed to “# of Pages” indicating the number of pages included in the job, and the “100” portion has content described according to the number of pages, such as
1-100 p/600 p (pages 1 through 100 out of 600 pages)
101-200 p/600 p (pages 101 through 200 out of 600 pages).

Also, the configuration is such that in the case that staple processing or the like occurs for each copy, the 17th job which is divided into two with a statement of instruction is not subject to stapling. Thus, in the case that the printed material wherein shared post-processing is performed is printed over two portions and a statement of instruction corresponding to each portion is created, simplifying the described content of the statement of instruction is desirable. For example, a method may be arranged wherein a page of printed material to be subject to post-processing and a page of printed material to perform post-processing along with the next printed material is described with the content of the post-processing so as to be distinguishable.

With the above-described specific example, in addition to information relating to post-processing performed as to a portion of printed material of the multiple printed materials, information is described indicating the relation between the portion of printed material of the multiple printed materials and the multiple printed materials. Such describing gives the advantage that the operator can more readily understand the positioning of the currently printed statement of instruction among all of the printing.

The image forming apparatus 102 that functions as the printing system with the present embodiment has multiple configuration conditions corresponding to the various types of control relating to the above-described first through fifth specific examples and the creation of statement of instructions described before the specific examples. However, as described above, the present invention should not be limited to this. For example, a printing apparatus and/or post-processing apparatus and/or printing system having at least one of the multiple configuration conditions relating to the creation of the statement of instruction is included in the present invention.

Also, with the above-described configuration, a configuration is exemplified wherein the controller 2100 functions as a unit to perform multiple determinations and controls relating to the creation of the statement of instruction, but should not be limited to this. For example, an arrangement may be made wherein a separate unit performs one of the determinations and/or controls of the multiple determinations and/or controls subject to execution by the controller 2100 with the configuration of the above-described present embodiment. Thus, for example, even with a configuration that the apparatus and/or system is controlled with one CPU, the present invention can be applied to a configuration wherein the apparatus and/or system is controlled by multiple coordinated CPUs.

Also, the present invention can be applied to a configuration that a program wherein the functions for the above-described embodiment are installed from the outside such as from a WEB server is executed with a host computer. Note that in this case, the configuration is such that data for displaying an operating screen similar to the operating screen described with the present embodiment which includes various operating screens is installed from the outside, and the various types of user interface screens can be provided to the display unit of the host computer. In this case, the present invention can also be applied in a case that an information group including the program is supplied to the output apparatus with a computer-readable storage medium such as a CD-ROM, flash memory, FD or the like, or from the external storage medium via a network.

Also, as described above, the present invention may be applied to a system made up of multiple devices, or may be applied to an apparatus made up of one device.

Also, the present invention supplies the computer-executable program of the software to realize the functions of the above-described embodiment, directly to the system or apparatus or remotely. The present invention can also be realized by the computer of the system or apparatus reading and executing the supplied program. In such a case, if the system has a program function, the embodiment does not have to be a program. Accordingly, in order to realize the function processing of the present invention with the computer system, a program code itself to be installed in the computer system also can realize the present invention.

That is to say, a computer program itself for realizing the function processing of the present invention is included in the scope of the present invention. In this case, the mode of a program is irrelevant as long as there is a program function, an may be object code, a program executed by an interpreter, script data supplied to the OS, or the like.

A computer-readable storage medium for supplying the program can be of various types. Examples include floppy disks, hard disks, optical disks (including such as CD-ROM, CD-R, CD-RW, DVD DVD-ROM, and DVD-R), magneto-optical disks (MO), magnetic tape, non-volatile memory cards, ROM, and so forth.

Also, as a program supply method, the program can be supplied by accessing a home page on the Internet using a browser on the client computer, and downloading the program to a storage medium such as a hard disk from the home page. In this case, the computer program itself of the present invention may be downloaded, or a compressed file including an automatic installation function may be downloaded.

Also, dividing the program code making up the program of the present invention into multiple files, and downloading each file from different home pages can also realize the present invention. That is to say, a WWW server for downloading a program file to realize the function processing of the present invention with a computer as to multiple users is also included in the scope of the present invention.

Also, an arrangement may be made wherein the program of the present invention is encrypted, stored in a storage medium such as a CD-ROM, and distributed to a user. In this case, a user having cleared predetermined conditions can download key information to decrypt the encryption from a home page via the Internet, with the program being installed in the computer in a format wherein the encrypted program can be executed by using the key information thereof.

Also, by the computer executing the read program, the functions of the above-described embodiment can be realized in a form other than the form in the embodiment. For example, based on the program instructions, an OS or the like running on the computer can perform a portion or all of the actual processing, whereby the above-described embodiment functions can be realized.

Further, an arrangement may be made wherein the program read from the storage medium is described in memory attached to a function expansion board inserted in the computer or a function expansion unit connected to the computer. In this case, subsequently, based on the program instructions, a CPU provided to the function expansion board or function expansion unit may perform a portion or all of the actual processing, whereby the above-described embodiment functions can be realized.

As described in the related art, an arrangement related to a statement of instruction is provided, whereby situations that may occur hereafter can be presumed, and an arrangement having flexibility as to the timing for creating the statement of instruction can be provided.

Also, according to the present embodiment, an arrangement is provided wherein the timing for creating the statement of instruction can be controlled in accordance with the situation of the printing apparatus (printing system) or by request from the operator.

Also, according to the present embodiment, an arrangement is provided wherein the statement of instruction having appropriate content described therein, so that even in a case that the timing for creating a statement of instruction can be controlled, problems do not occur in the subsequent work, can be provided.

Thus, for example, even in a case wherein the accumulation capacity of printed material in a ejecting unit such as a stacker has been exceeded, the arrangement herein prevents problems from occurring such as the statement of instruction not being printed until all of the jobs have ended. Also, statement of instructions can be printed for every specified number of copies during execution of the printing job, and the operator can receive the statement of instructions at a desired timing. Also, the arrangement herein prevents problems from occurring such as the statement of instruction not being printed because the output of printed material has been interrupted for some reason, and a statement of instruction having appropriate work content for the printed material already output can be created.

Thus, with the arrangement of the present embodiment, an arrangement that contributes to the realization of products which enable the creation of statement of instructions can be provided. Note that the present embodiment can be applied to a configuration wherein of the advantages described above, at least one advantage can be enjoyed, even if the configuration does not satisfy all of the advantages of the present embodiment.

Thus, the present invention is not limited to the embodiments described above, and can have various types of modifications based on the intent of the present invention (including organized combinations of the various embodiments), and these are not to be excluded from the scope of the claims.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims the benefit of Japanese Patent Application No. 2008-037565 filed Feb. 19, 2008, which is hereby incorporated by reference herein in its entirety.

What is claimed is:

1. An information processing apparatus that can cause a printing unit to print a job including a plurality of printed materials in one job, the information processing apparatus comprising:
a describing unit that describes information relating to post-processing performed as to a portion of the printed material of the plurality of printed material to be printed with the printing unit, as a statement of instruction to be outputted by an outputting unit.

2. The information processing apparatus according to claim 1, wherein the describing unit describes information showing the relation between a portion of the printed material of the plurality of printed material and the plurality of printed material, in addition to the information relating to post-processing performed as to a portion of the printed material of the plurality of printed material, as the statement of instruction.

3. The information processing apparatus according to claim 1, further comprising:
a specifying unit to specify timing to output the statement of instruction with the outputting unit according to user instructions; wherein
the describing unit describes the information relating to post-processing performed as to a portion of the printed material of the plurality of printed material, in accordance with the timing specified by the specifying unit, as the statement of instruction.

4. The information processing apparatus according to claim 3, wherein the timing specified by the specifying unit includes at least one of
every time a specified number of copies of printed material is printed,
every time a specified number of sheets of printed material is printed,
every time a predetermined amount of time passes,
every time a print interruption cause occurs, and
every time printing according to the post-processing is performed.

5. The information processing apparatus according to claim 1, wherein in the case that a print interruption cause occurs during printing of the plurality of printed materials by the printing unit, the describing unit describes information relating to post-processing performed as to a portion of printed material printed up to the time before the interruption cause occurred.

6. The information processing apparatus according to claim 1, wherein the describing unit further comprises:
a first describing unit to describe information relating to post-processing as to the plurality of printed materials printed with the printing unit, as a statement of instruction; and
a second describing unit to describe information relating to post-processing performed as to a portion of printed material of the plurality of printed materials printed with the printing unit, as a statement of instruction.

7. The information processing apparatus according to claim 6, wherein the describing unit outputs the statement of instruction after the plurality of printed materials are printed by the printing unit, in the case of executing description by the first describing unit.

8. An image forming apparatus comprising:
a printing unit to print a plurality of printed materials included in one job; and
an outputting unit to output a statement of instruction wherein information is described relating to post-processing performed as to a portion of printed materials of the plurality of printed materials output by the printing unit.

9. The image forming apparatus according to claim 8, further comprising:
a describing unit to describe information relating to post-processing performed as to a portion of printed materials of the plurality of printed materials printed by the printing unit, as a statement of instruction.

10. The image forming apparatus according to claim 9, wherein the describing unit describes information showing the relation between a portion of the printed material of the plurality of printed material and the plurality of printed material, in addition to the information relating to post-processing performed as to a portion of the printed material of the plurality of printed material, as the statement of instruction.

11. The image forming apparatus according to claim 8, further comprising:
a specifying unit to specify timing to output the statement of instruction according to user instructions, wherein
the outputting unit outputs the statement of instruction, wherein information is described relating to post-processing performed as to a portion of the printed material of the plurality of printed material, in accordance with the timing specified by the specifying unit, at a timing specified by the specifying unit.

12. The image forming apparatus according to claim 11, wherein the timing specified by the specifying unit includes at least one of
every time a specified number of copies of printed material is printed,
every time a specified number of sheets of printed material is printed,
every time a predetermined amount of time passes,
every time a print interruption cause occurs, and
every time printing according to the post-processing is performed.

13. The image forming apparatus according to claim 8, wherein in the case that a print interruption cause occurs during printing of the plurality of printed materials by the printing unit, the outputting unit outputs the statement of instruction wherein information is described relating to post-processing performed as to a portion of printed material printed up to the time before the interruption cause occurred of the plurality of printed materials.

14. The image forming apparatus according to claim 13, wherein in the case that the statement of instruction cannot be printed because of the print interruption cause, the outputting unit has a unit to create the statement of instruction with a method other than printing with the image forming apparatus.

15. The image forming apparatus according to claim 14, wherein a unit to create the statement of instruction with a method other than printing with the image forming apparatus includes at least one of a unit to transmit the statement of instruction to an external apparatus by e-mail, a unit to transmit the statement of instruction to an external apparatus by I-fax, a unit to save the statement of instruction on a file server, a unit to store the statement of instruction in a box, and a unit to display the statement of instruction on a display unit.

16. A printing system that can cause a printing unit to print a job including a plurality of printed materials in one job comprising:
a describing unit that describes information relating to post-processing performed as to a portion of printed material of the plurality of printed material to be printed with the printing unit, as a statement of instruction; and
an outputting unit that outputs the statement of instruction described with the describing unit.

17. An information processing method comprising the steps of:
printing a job including a plurality of printed materials in one job;
describing information relating to post-processing performed as to a portion of printed material of the plurality of printed material to be printed in the printing step, as a statement of instruction; and
outputting the described statement of instruction.

18. The information processing method according to claim 17, wherein in the describing step, information showing the relation between a portion of the printed material of the plurality of printed material and the plurality of printed material is described, in addition to the information relating to post-processing performed as to a portion of the printed material of the plurality of printed material, as the statement of instruction.

19. The information processing method according to claim 17, comprising the step of:
specifying timing to output the statement of instruction in the outputting step according to user instructions; wherein
in the describing step, information is described relating to post-processing performed as to a portion of the printed material of the plurality of printed material, in accordance with the timing specified in the specifying step, as the statement of instruction; and
in the outputting step, outputting the statement of instruction at a timing specified in the specifying step.

20. The information processing method according to claim 19, wherein the timing specified in the specifying step includes at least one of
every time a specified number of copies of printed material is printed,
every time a specified number of sheets of printed material is printed,
every time a predetermined amount of time passes,
every time a print interruption cause occurs, and
every time printing according to the post-processing is performed.

21. The information processing method according to claim 17, wherein in the describing step, in the case that a print interruption cause occurs during printing of the plurality of printed materials in the printing step, information is described relating to post-processing performed as to a portion of printed material printed up to the time before the interruption cause occurred of the plurality of printed materials, as a statement of instruction.

22. The information processing method according to claim 21, wherein in the outputting step, in the case that the statement of instruction cannot be printed because of a print interruption cause, a statement of instruction is created with a method other than printing.

23. The information processing method according to claim 22, wherein a method other than printing includes at least one of transmitting the statement of instruction to an external apparatus by e-mail, transmitting the statement of instruction to an external apparatus by I-fax, saving the statement of instruction on a file server, storing the statement of instruction in a box, and displaying the statement of instruction on a display unit.

24. A computer-readable storage medium storing a computer-executable process, the computer-executable process causing a computer to implement a method comprising:
printing a job including a plurality of printed materials in one job;
describing information relating to post-processing performed as to a portion of printed material of the plurality of printed material to be printed in the printing step, as a statement of instruction; and
outputting the described statement of instruction.
